(19) United States
(12) Patent Application Publication
(10) Pub. No.: US 2008/0065370 A1
(43) Pub. Date: Mar. 13, 2008

(54) Support apparatus for object-oriented analysis and design

(76) Inventor: Takashi Kimoto, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/518,180

(22) Filed: Sep. 11, 2006

(51) Int. Cl. G06F 17/27

(52) U.S. Cl. 704/9

(57) ABSTRACT

A support apparatus for object-oriented analysis and design comprising: a sentence input section that receives as input a plurality of sentences of the requirement and the design paper of a system as scenario; a sentence pickup section that picks up the input plurality of sentences one by one sequentially from the sentence input section; a subject extracting section that extracts the noun that makes the subject from one of the sentences picked up as target; an object extracting section that extracts the noun as object object; a verb extracting section that extracts the verb of the sentence; and a continuous sentences linking condition confirming section that checks the link of the first sentence and the second sentence; and a class figure preparing section that prepares a class figure from the subject object of the first sentence and the subject object of the second sentence and the link condition.

### BACKGROUND OF THE INVENTION

(1) Field of the Invention

This invention relates to an apparatus for supporting software analysis and design in the field of information processing technology and, more particularly, it relates to a support apparatus for object-oriented analysis and design.

(2) Description of the Related Art

Methodologies of object-oriented analysis and design have been and are regarded increasingly important as methodologies of software analysis and design.

Such methodologies are not the methodology in the process-oriented and the methodology in the dater-oriented but the methodologies to manage by consolidate objects, operations of objects and attributes of objects so as to manage them in a coordinated manner.

With object-oriented methodologies, the designer normally extracts objects from a requirement of a system and draws a class figure. However, with conventional methods, the outcome of analysis differs from designer to designer to give rise to a problem in design works.

To cope with this problem, there have been proposed techniques for mechanically obtaining the outcome of analysis that is useful for object-oriented programming from a requirement specification, using sentence structures that are obtained by processing the Japanese language. “CAMEO/A: an Object-oriented Analysis System and Learning of Rules by Inductive Reasoning—Object-oriented Front Line”, p. 57, Asakura Publishing Co., Ltd.

The above-cited system is the system which automates the process of extracting elements constituting an object figure and an event trace figure from a requirement sentence of a natural language in order to automate object-oriented analyses. According to this system, the noun becomes a class and the verb phrase becomes related.

This processing processes in Japanese analysis to the request sentence by the native language, it extracts a class, an attribute and so on from the noun and it extracts relation (the concentration), operation, redundant relation from the verb as each element, it cancels the one which faces in the thing boiling with existing ambiguousness and competes.

Then, each class candidate is determined to be active or passive and finally processed typically so as to be replaced by a class representative having a redundant relationship. Since the process is executed on a requirement sentence in a natural language, the objects obtained by this process include those that are not necessary.

Deletions, alterations and additions of objects normally take place in the course of repetition of analysis. This is an operation that has to rely on manpower and hence is time consuming.

Additionally, as Chomsky, the well known authority of linguistics of the world, said that “the human can create sentences of infinite patterns” ( ), it is currently theoretically very difficult to prepare a system that can accurately analyze the meaning of each of various sentences that people freely produce.

Jpn. Pat. Appln. Laid-Open Publication No. 10-307717 discloses an analysis and design method for software of obtaining data on sentence structures from a requirement specification by processing the Japanese language, preparing a dictionary of the verbs contained in the data, extracting verb objects and giving them relevancies with other cases.

However, while the disclosed technology draws relevancies from verbs, it cannot indicate contradictions and errors in the class relevancies extracted from a plurality of sentences because it is difficult to see the linkage of verbs and nouns.

### BRIEF SUMMARY OF THE INVENTION

Known support apparatus for object-oriented analysis and design are accompanied by a problem of being unable to accurately draw a class figure.

Therefore, an aspect of the present invention is to provide a support apparatus for object-oriented analysis and design that can draw an objective class figure with ease.

Other aspect of the present invention is to provide A support apparatus for object-oriented analysis and design comprising: a sentence input section that receives as input a plurality of sentences of the requirement and the design paper of a system as scenario; a sentence pickup section that picks up the input the plurality of sentences one by one sequentially from the sentence input section; a subject extracting section that extracts the noun that makes the subject from one of the sentences picked up as target from the requirement of the system by the sentence pickup section; an object extracting section that extracts the noun as object object on the basis of the input sentences; a verb extracting section that extracts the verb of the sentence on the basis of the input sentences; a continuous sentences linking condition confirming section that checks the link of the first sentence and the second sentence, by confirming there is an object object, it differs from the subject object of the same sentence, and the agreement of the object object of the first sentence with the subject object of the second sentence found somewhere after the first sentence in the relationship of the subject objects and the object objects of the first sentence and the second sentence as extracted by the subject extracting section and the object extracting section; and a class figure preparing section that prepares a class figure from the subject object of the first sentence and the subject object of the second sentence and the link condition of the first sentence and the second sentence confirmed by the continuous sentences linking condition confirming section.

### BRIEF DESCRIPTION OF THE DRAWINGS

FIG. 1 is a schematic block diagram of the first embodiment of support apparatus for object-oriented analysis and design adapted to be applied to the Japanese language, illustrating the configuration thereof;

FIG. 2 is a summarized flowchart of the operation of the first embodiment of support apparatus for object-oriented analysis and design according to the invention;

FIG. 3 is a flowchart of the operation of the first embodiment of support apparatus for object-oriented analysis and design according to the invention;

FIG. 4 is an example of word character string table that can be used for the purpose of the invention;

FIG. 5 is a table showing as examples nouns and a verb that can be registered in the word dictionary 31 of FIG. 1;

FIG. 6 is a flowchart of the operation of analyzing an input sentence by the first embodiment of support apparatus for object-oriented analysis and design according to the invention;

FIG. 7A shows a scenario, a series of Japanese sentences that may be input to the first embodiment of support apparatus for object-oriented analysis and design according to the invention;

FIG. 7B is a schematic illustration of an example of operation on a subject object in the case of the series of Japanese sentences of FIG. 7A;

FIG. 8 is a schematic illustration of an example of analysis table showing the outcome of the above process stored in the analysis dictionary 32 of FIG. 1;

FIG. 9 is a flowchart of the operation of preparing a class figure by using the table of FIG. 8;

FIG. 10 is a schematic illustration of an example of class figure that can be prepared according to the present invention;

FIG. 11 is a flowchart of a simplified input operation that is conducted without analyzing the input sentence and hence without discriminating a subjects object and other elements according to the present invention;

FIG. 12 is a schematic illustration of an example of image that can be displayed in the second embodiment of the invention that uses a simplified input system;

FIG. 13 is a flowchart of the operation of the third embodiment of the invention when an English sentence is input.

### DETAILED DESCRIPTION OF THE INVENTION

Before describing preferred embodiments of the present invention, the basic concept of the present invention will be described firstly. The present invention is based on the phrase structure rules proposed by Chomsky as part of his generative grammar for linguistics.

According to the phrase structure rules proposed by Chomsky, a sentence comprises a noun phrase and a verb phrase and a noun phrase by turn comprises a “noun that makes the subject” of the entire sentence and an article or an adjective, while a verb phrase comprises a verb and a noun phrase or an adverb phrase. The noun of the noun phrase contained in a verb phrase makes a “noun as object”. According to his generative grammar, a “noun that makes the subject” is referred to as an actor or an experiencer and a “noun as object” is referred to as an acted or the theme.

In a language analysis program that is used for the purpose of the present invention, a “noun that makes the subject” is extracted as subject object and a “noun as object” is extracted as object object, while manipulations and attributes are extracted from a verb and one or more than one adverb phrases.

Thus, it is possible to mechanically and automatically extract objects from a system requirement and provide clear grounds. Therefore, the extracted objects do not differ from person to person.

For the ease of application of the phrase structure rules proposed by Chomsky, it is assumed here that a sentence contains only a noun phrase and a verb phrase. However, the present invention does not rule out that a sentence may contain two objects because a verb phrase includes a noun phrase.

The basic concept of the present invention will now be described below.

For object-oriented analysis and design, a class figure is most important from the viewpoint of grasping a system. A class figure shows the elements (the objects and the classes extracted from documents) of a system to be handled and their relations.

The requirement and the design paper of a system describe the specification of a plurality of functions that the system has to realize and the specification of each item is formed by a series of sentences.

A computer system comprises a plurality of functions, which have an antero-posterior relationship in terms of order of processes. More specifically, function A requests function B for a process, function B requests function C for another process and function C requests function D for still another process and so on so that processes are executed sequentially one after another. Function A that executes a preceding process (class A) manipulates function B (class B) that executes a succeeding process and function B (class B) manipulates function C (class C) that executes a succeeding process.

In this way, the processing of a system is executed continuously, showing relevancies. Since processes are linked and executed by a system, the class that makes the subject of a sentence that is described makes the class of object of a preceding sentence in the requirement or the design paper of the system. On the basis of this simple idea, it is possible to extract objects from a series of sentences and prepare class figures, concurrently verifying errors of the class figures with ease.

Now, the present invention will be described by way of preferred embodiments.

### First Embodiment

Now, the first embodiment of support apparatus adapted to be applied to the Japanese language and prepare a class figure will be described below.

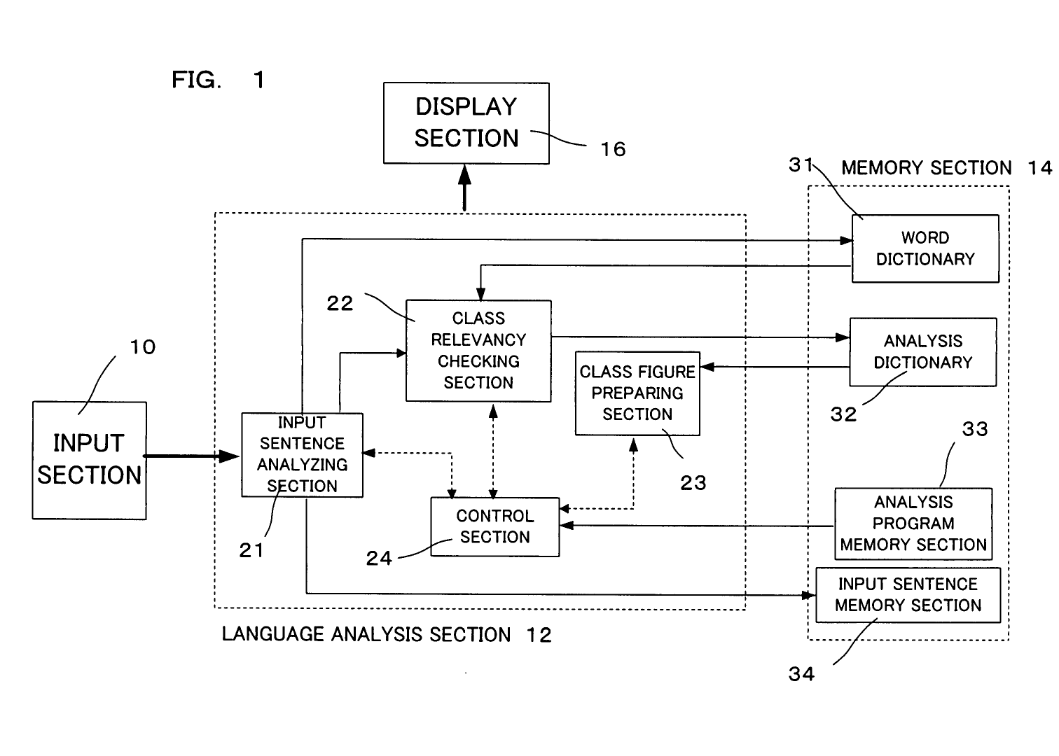

FIG. 1 is a schematic block diagram of the first embodiment of support apparatus for object-oriented analysis and design adapted to be applied to the Japanese language, illustrating the basic configuration thereof. The support apparatus has an input section 10 for receiving as input the requirement of a system and sentences for analytic design (design paper), a language analysis section 12 for analyzing the sentences input from the input section 10, a memory section 14 for storing the outcome of analysis produced by the language analysis section 12 and a display section 16 for displaying the outcome of analysis produced by the language analysis section 12.

The language analysis section 12 includes an input sentence analyzing section 21 for analyzing the sentences input from the input section 10, a class relevancy checking section 22 for detecting class relevancies as will be described in greater detail hereinafter, a class figure preparing section 23 for preparing class figures and a control section 24 for controlling the input sentence analyzing section 21, the class relevancy checking section 22 and the class figure preparing section 23.

The memory section 14 includes a word dictionary 31 for registering words from the sentence analyzed by the input sentence analyzing section 21 of the language analysis section 12 and sending them to the class relevancy checking section 22, an analysis dictionary 32 for receiving the sentence being analyzed from the class relevancy checking section 22 and sending the outcome to the class figure preparing section 23, an analysis program memory section 33 for storing a predetermined program for language analysis and sending the analysis program to the control section 24 and an input sentence memory section 34 for receiving sentences as input from the input section 10 and storing the input sentences through the input sentence analyzing section 21. The analysis program memory section 33 stores the analysis program in a predetermined format and the input sentence memory section 34 stores the requirement of the system in a predetermined format.

The input section 10 is a unit to be used by the operator for inputting the registration of nouns and verbs to the word dictionary 31, the registration of types to the analysis dictionary 32 and modifying information for the class figures prepared by the class figure preparing section 23.

The analysis dictionary 32 of the memory section 14 registers the outcome of analysis of the input sentences and information on the relationship of higher and lower orders. As a sentence is input from the input section 10, the subject, the object and the verb of the sentence are recorded in the word dictionary 31 according to a word dictionary registration order. If necessary, the operator can access the word dictionary 31 and alter the recorded contents.

The word dictionary 31 holds a word division character string table (to be referred to as character string table hereinafter) storing separating characters that indicate, or operate as, separating characters and the attribute of the immediately preceding character string showing if the immediately preceding character string operates as subject, object or verb in a coordinated manner.

Now, the operation of the support apparatus will be described by referring to flowcharts.

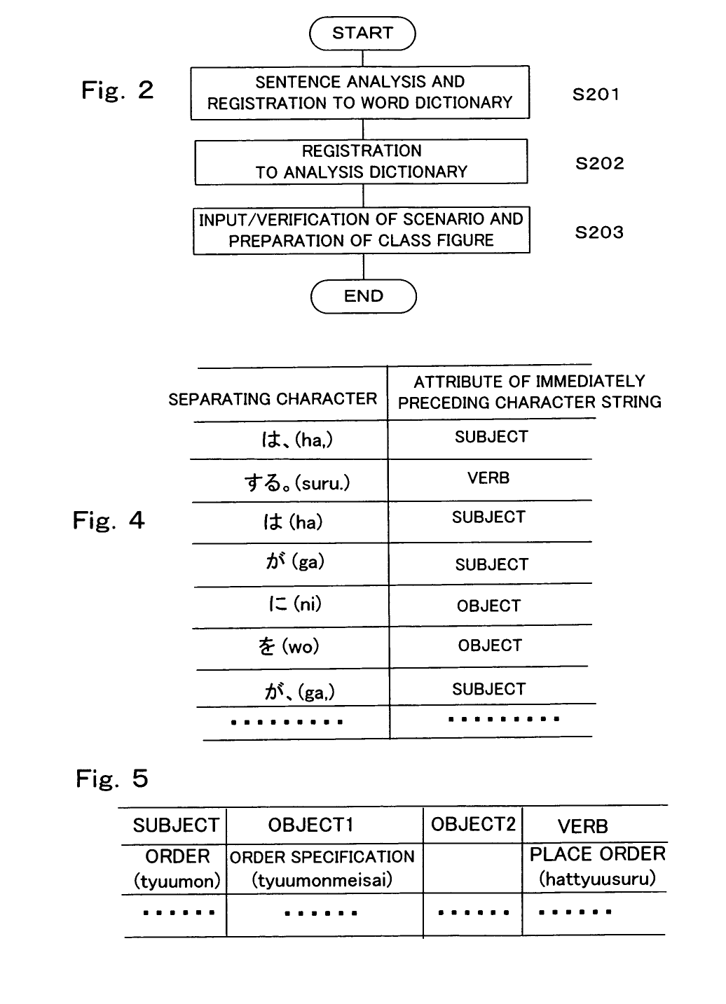

FIG. 2 is a summarized flowchart of the operation of the first embodiment of support apparatus for object-oriented analysis and design according to the present invention. As the requirement of the system, a series of Japanese sentences to be analyzed are input by way of the input section 10, the sentences are subjected to a language analysis process and a process of registering to the word dictionary 31 on a sentence by sentence basis in Step S201. Then, the subject objects, the object objects, the manipulations and the attributes extracted as a result of the language analysis process executed in Step S201 are registered in the analysis dictionary 32 in Step S202. In the next step, Step S203, the prepared scenario is input and verified according to the outcome of the preparation of the scenario and a class figure is prepared.

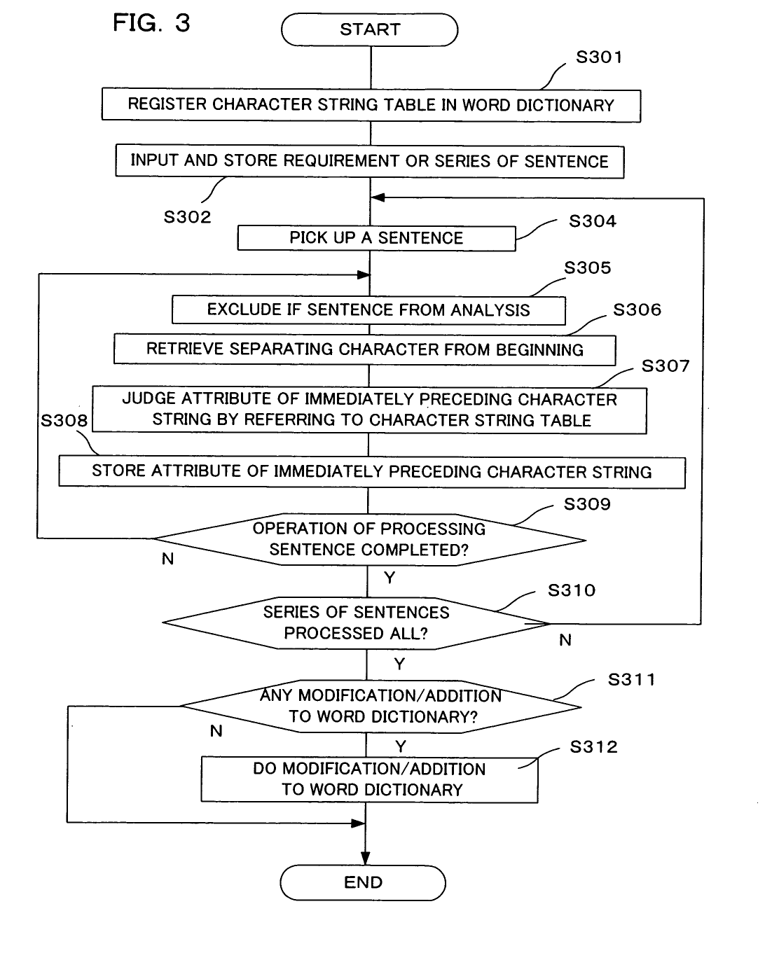

Now, the above processing steps will be described in greater detail below. Firstly, the sentence analysis process of Step S201 will be described by referring to the flowchart of FIG. 3.

In this step, the program stored in the analysis program memory section 33 is sent to the input sentence analyzing section 21 to analyze the sentences input by way of the input section 10.

Firstly, in Step S301, a character string table, which will be described in greater detail, is registered in advance in the word dictionary 31. Then, a series of sentences that form a block in terms of meaning in the requirement of the system are input sequentially and stored in the input sentence memory section 34 (Step S302). A series of sentences that form a block in terms of meaning is referred to as scenario.

The input sentence analyzing section 21 retrieves a separating character serving as punctuation of a sentence. If there are found “ha” [symbol] , “ga” [symbol] and an object, the character string immediately preceding the character string corresponding to the separating character is registered in the word dictionary 31, whereas if there is found a verb, the character string immediately preceding the character string corresponding to the separating character is registered in the word dictionary 31.

The input sentence analyzing section 21 picks up the first sentence in Step S304. In the next step, or Step S306, it checks the picked up sentence from the beginning and retrieves one or more than one separating characters by referring the same separate character to the character string table of the word dictionary 31.

FIG. 4 is an example of word character string table that can be used for the purpose of the invention. A character string table shows separating characters that divide each of the input sentences and the attribute of the immediately preceding character string if there is a character string, that is, shows whether the character string belongs to a subject and an object or a verb. Separating characters include “suru (do)” [symbol] , “ha” [symbol] , “ga” [symbol] , “ha” [symbol] , “ga,” [symbol] , “ni” [symbol] , “wo” [symbol] , etc.

In the case of the table of FIG. 4, each sentence is divided into a subject and a verb in such a way that the character string that precedes “suru (do)” [symbol] is a verb and the character string that precedes “ha” [symbol] , “ga” [symbol] , “ha,” [symbol] or “ga,” [symbol] is a subject. The character string that precedes “ni” [symbol] or “wo” [symbol] may be judged to be an object. If a sentence is led by a passage of “if . . . ”, the passage is excluded from the analysis.

FIG. 5 is a table showing as examples a subject, an object and a verb that can be registered in the word dictionary 31. For example, the character string of “an order” is stored in the word dictionary 31 as subject and the character structure of “place” is stored in the word dictionary 31 as verb.

Returning to FIG. 3, in Step S306, a separating character is retrieved from the beginning of the sentence. In the next step, Step S307, the character string immediately preceding the separating character is judged to be a noun or a verb by referring to the character string table in the word dictionary 31. The outcome of the judgment is stored in the input sentence memory section 34 as that part of the sentence (Step S308).

In the next step, Step S309, it is determined if the above-described attribute judging process is completed all the way down to the end of the picked up sentence and, if it is determined that the process is not completed yet, the processing operation returns to Step S306 and a separating character is retrieved from the next part of the sentence.

In this way, the process of searching for separating characters sequentially from the beginning of a picked up sentence, judging if the character string immediately preceding each separating character is a subject or an object or a verb by referring to the character string table and storing the outcome of the judgment is executed (Steps S306, S307, S308). The process is referred to as attribute judgment process. The outcome of the judgment is stored in the input sentence memory section 34.

In step S309, if storing the outcome of the judgment is executed that the attribute judgment process for a sentence has been completed, the processing operation proceeds to step S310. Then, it is detected whether the attribute judgment process has been completed in a series of sentences input and stored in step S302.

If there is a sentence that has not been subjected to the attribute judgment process, such a process is executed for the remaining sentence. More specifically, the next sentence is picked up in Step S306 and a separating character is retrieved from the beginning of the sentence in Step S306. The attribute of the character string immediately preceding the separating character is stored.

If it is determined in Step S310 that all the series of sentences have been subjected to the attribute judgment process, the contents of the word dictionary 31 are displayed on the display section 16 to ask if the operator do one or more than one modifications and/or additions to the word dictionary 31 or not, prompting the operator to click “yes” or “no” also displayed on the display section 16. If the operator clicks “yes” typically by means of the mouse of the input section 10, the processing operation proceeds to Step S312. In Step S312, the operator does one or more than one modifications and/or additions to the contents of the character string table of the word dictionary 31.

If, on the other hand, the operator clicks “no” on the display section 16, the attribute judgment process is completed on the series of sentences.

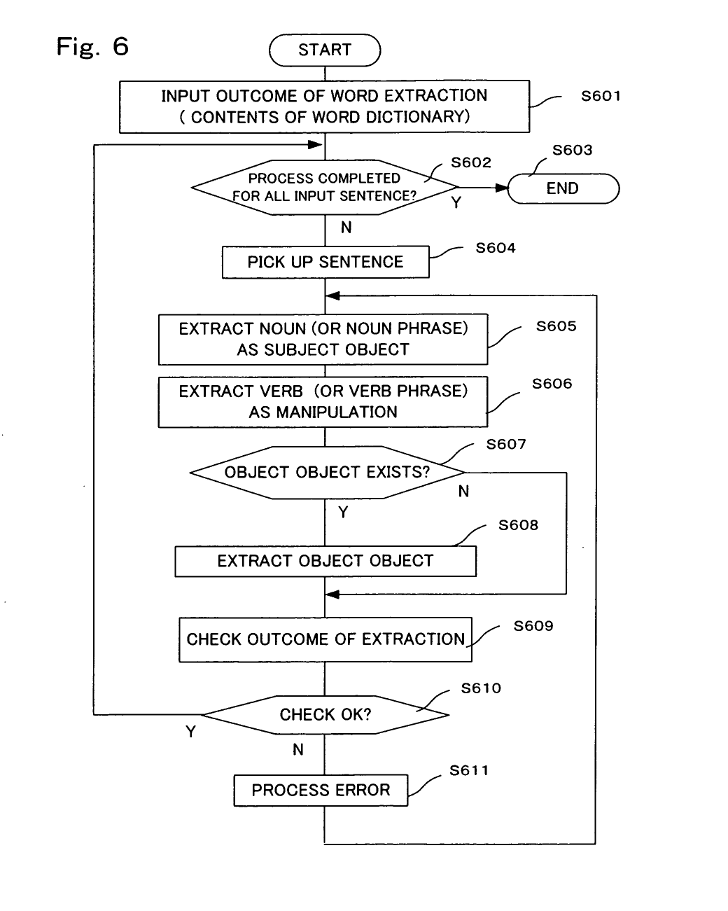

Now, the process of registration to the analysis dictionary for an input document written in Japanese (S202) will be described below by referring to the flowchart of FIG. 6. The process that is described below is executed by the class relevancy checking section 22 shown in FIG. 1 and the outcome of the process is stored in the analysis dictionary 32.

In Step S601, the series of sentences is input and it is determined in Step S602 if a process as described below is completed for all of the input sentences or not. The process ends when it is completed on all of the input sentences (Step S603).

If the process is not completed for all of the input sentences, the sentences are picked up one by one and subjected to a process as described below.

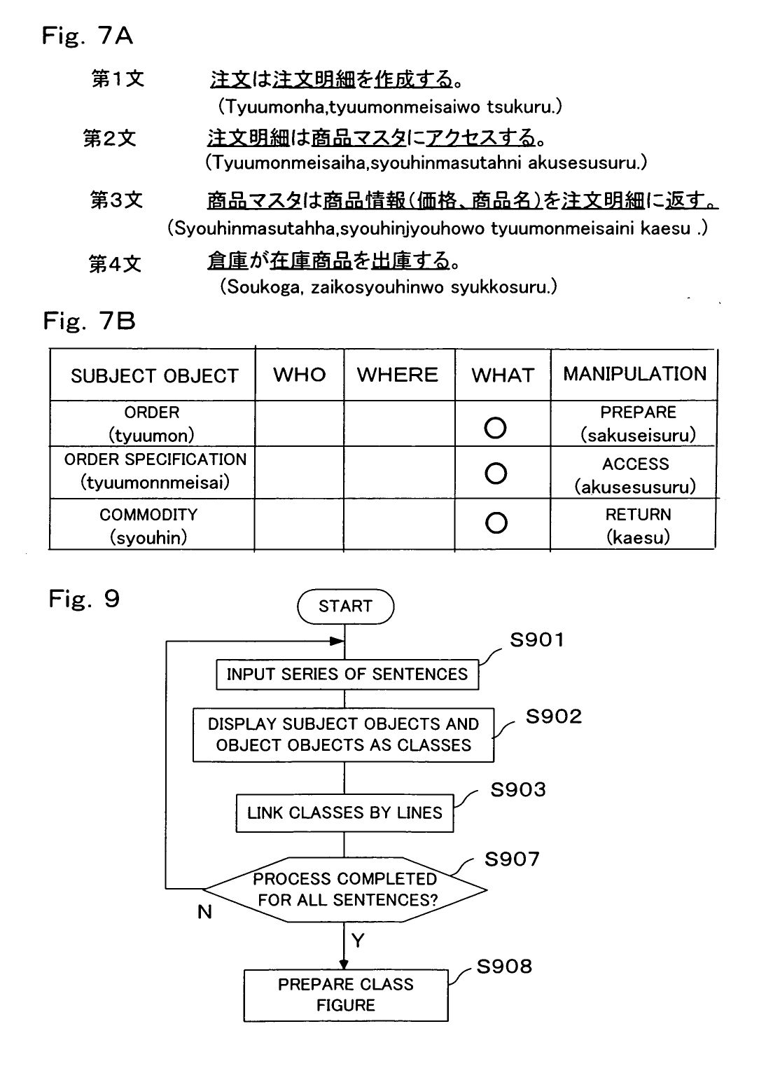

FIG. 7A illustrates a series of Japanese sentences that may be input for ordering commodities. The scenario includes three sentences, or the first sentence, the second sentence and the third sentence. The first sentence is “The order prepares an order specification.” (Tyuumonha, tyuumonmeisaiwo tsukuru. [symbol] [symbol] [symbol] The second sentence is “The order specification accesses the commodity master.” (Tyuumonmeisaiha, syouhinmasutahni akusesusuru [symbol] [symbol] [symbol] The third sentence is “The commodity master returns commodity information (the prices, the names of commodities) to the order specification.” (Syouhinmasutahha, syouhinjyouhouwo tyuumonmeisaini kaesu.

[symbol]

[symbol]

[symbol]

[symbol]

In Step S605, a noun or a noun phrase is extracted as subject object. In the instance illustrated in FIG. 7A, as the first sentence is picked up in Step S604, separating character “ha” [symbol] as shown in FIG. 4 is detected from the first sentence of “The order prepares an order specification.” (Tyuumonha, tyuumonmeisaiwo tsukuru. [symbol] [symbol] in step S605 and “the order” [symbol] preceding it is extracted as noun-object. In such a case, if “(a) ha” [symbol] or “(a) ga” [symbol] is found in the sentence, (a) is extracted as subject object.

In the next step, or Step S606, a verb or a verb phrase is extracted as manipulation, taking the separating characters shown in FIG. 4 into consideration.

In such a case, if an expression of “(a) does (b)” ((a [symbol] b [symbol] is found, (b) is extracted as verb. Thus, “prepares” (sakuseisuru [symbol] is extracted as verb from the first sentence.

In the next step, or Step S607, it is determined if there exists an object object or not. If there exists an expression that “do (e) something (d) to (c)” ((c [symbol] d) [symbol] (c) and (d) are extracted as object objects. If there exists a description of “(f, g)” after the object object, f and g are regarded as attributes. The expression of “do (e)” ((e [symbol] is extracted as manipulation.

If it is determined in Step S607 that there exists an object object, the object object is extracted in Step S608.

In the next step, or Step S609, if the outcome of extraction is right or not is checked by seeing if the predetermined requirements as described below are satisfied or not.

The first requirement is that there exists a single subject object. The second requirement is that there exist one or more than one object objects or there exists no object object. The third requirement is that the subject object of each of the sentences other than the sentence at the head is found as object object of some of the preceding sentences with the same name. The fourth requirement is that, if there is an object object, it differs from the subject object of the same sentence. The fifth requirement is that if the object object of a sentence (the N-th sentence) is same as the subject object of a preceding sentence, the subject object of the sentence next to that sentence (the N+1-th sentence) does not need to be same as the object object of the preceding sentence.

These requirements will be described below by referring to the example illustrated in FIG. 7A. The subject object of the first sentence is “order” (tyuumon; [symbol] and the subject object of the second sentence is “order specification” (tyuumonmeisai [symbol] while the subject object of the third sentence is “commodity master” (syouhinmasutah [symbol] but reduced to “commodities” (syouhin [symbol] by removing master. Thus, each of the three sentences has a single subject object so that it meets the first requirement. Additionally, the object object of the first sentence is “order specification” (tyuumonmeisai [symbol] and the object object of the second sentence is “commodities” (syouhin [symbol] while the object objects of the third sentence are “commodity information” (syouhinzyouhou [symbol] and “order specification” (tyuumonmeisai [symbol] Thus, all the three sentences meet the second requirement.

The expression of “order specification” (tyuumonmeisai [symbol] that is the subject object of the second sentence agrees with “order specification” (tyuumonmeisai [symbol] that is the object object of the immediately preceding first sentence. Thus, the second sentence meets the third requirement. The expression of “order specification” (tyuumonmeisai [symbol] that is the subject object of the second sentence differs from “commodities” (syouhin [symbol] that is the object object of the second sentence. Thus, the second sentence meets the fourth requirement.

In the next step, or Step S610, it is checked if the outcome of extraction meets the above four requirements or not and, if it does, the processing operation returns to Step S602 to determine if the process of extracting the subject object of each and every one of the input sentences, or the scenario, is completed or not. If the process is not completed, the processing operation moves to Step S604, where the next sentence is picked up.

If, on the other hand, the above-described requirements are not met as a result of the checking operation in Step S610, an error correcting process is executed in Step S611 and the processing operation returns to Step S605, where the operation of extracting the subject object of each of the sentences and other operations of Steps S605 through S609 are repeated or all the sentences are modified after the operations in Steps S605 through S609 and the operations in Steps S601 through 609 are repeated. The outcome of the process executed in this way is stored in the analysis dictionary 32.

In Step S610, the outcome of the extraction is checked. The specific requirements to met in the checking operation include that a noun or a noun phrase exists as subject object, that a verb or a verb phrase that expresses the action or state of the subject object exists, that the subject object of each of the sentences other than the leading sentence is found as the object object of the same name in a preceding sentence or in the first sentence of the scenario (in the case where the object object of the immediately preceding sentence is same as the subject object of a more preceding sentence) and that the object object of any of the sentences differ from the subject object of the same sentence. When the requirements of the checking operation are not met, the processing operation moves to Step S611 for an error correcting operation and then returns to Step S605 once again for processing the sentences once again. When the checking operation is completed satisfactorily, the outcome of the process is stored in the analysis dictionary 32.

When the checking operation is completed satisfactorily, the processing operation returns to Step S602, where it is determined if all the sentences have been processed or not. If all the sentences have not been processed yet, the processing operation proceeds to Step S604, where the next sentence is picked up.

If, on the other hand, it is determined in Step S606 that there exists a verb phrase in the sentence being processed, a noun is extracted from the verb phrase as object object.

The series of sentences that are analyzed are managed as a plurality of sub-scenarios that can be managed collectively. There are typically three categories of WHO, WHERE and WHAT into which subject objects are sorted so that they may be registered.

The category WHO is set up for trading partners, clients, etc., and the category WHERE is set up for places such as warehouses, rooms, shelves and so on, while the category WHAT is set up for orders, order specifications, commodities, prices, etc. FIG. 7B shows the relationship of the subject objects, WHAT and the manipulations on the first three sentences in FIG. 7A. In the first sentence, the subject object is “order” (tyuumon [symbol] and the manipulation is “prepare” (sakuseisuru [symbol] . In the second sentence, the subject object is “order specification” (tyuumonmeisai [symbol] and the manipulation is “access” (akusesusuru [symbol] . In the third sentence, the subject object is “commodities” (syouhin [symbol] and the manipulation is “return” (kaesu; [symbol] .

For the purpose of preparing an easily understandable class figure, as shown FIG. 7B it is so arranged that the order according to which the subject objects are linked can be set and registered in advance.

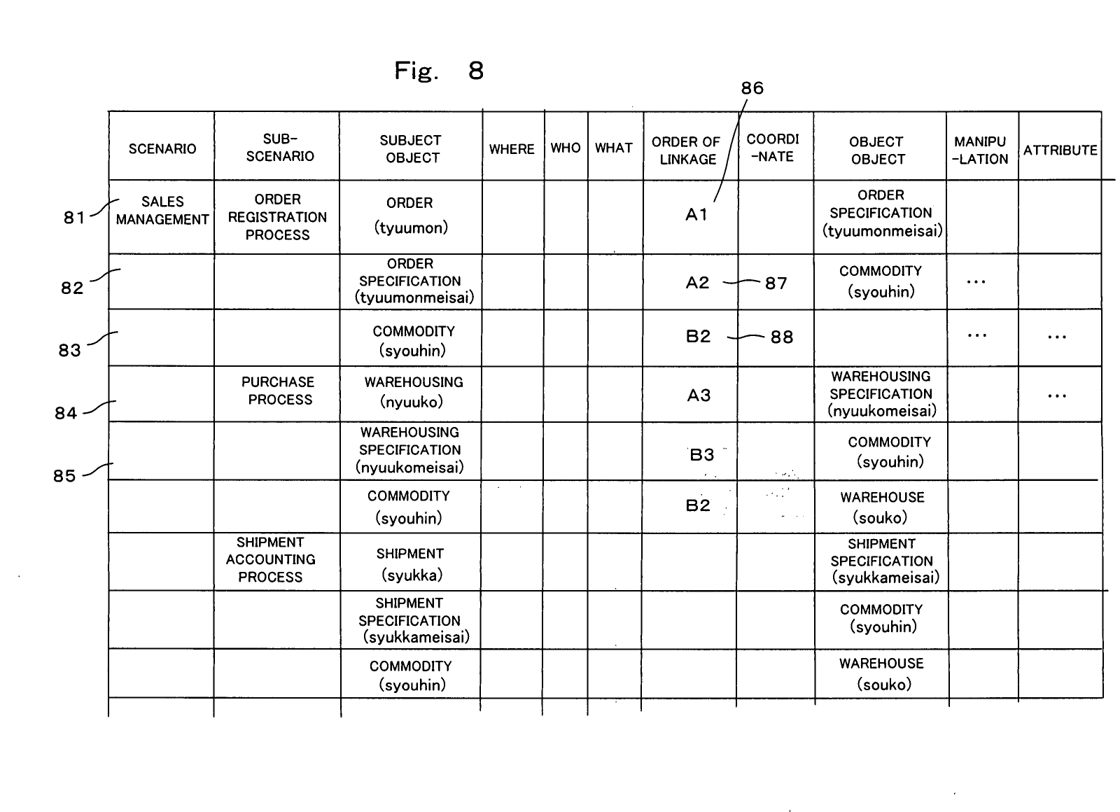

FIG. 8 shows an example of analysis dictionary 32 that stores the outcome of the above process. In the example of analysis dictionary, the scenario is sales management that is divided into sub-scenarios of order registration process, purchase process and shipment summing up process. In FIG. 8, 81, 82 and 83 indicate respectively the section of the outcome of analysis of the first sentence, the section of the outcome of analysis of the second sentence and the section of the outcome of analysis of the third sentence. In the first sentence, the subject object is order and the object object is order specification.

Now, preparation of a class figure that takes place after the above-described analysis of sentences will be described below. The class figure preparing section 23 of FIG. 1 is responsible for preparation of class figures. FIG. 9 is a flowchart of the operation of preparing a class figure.

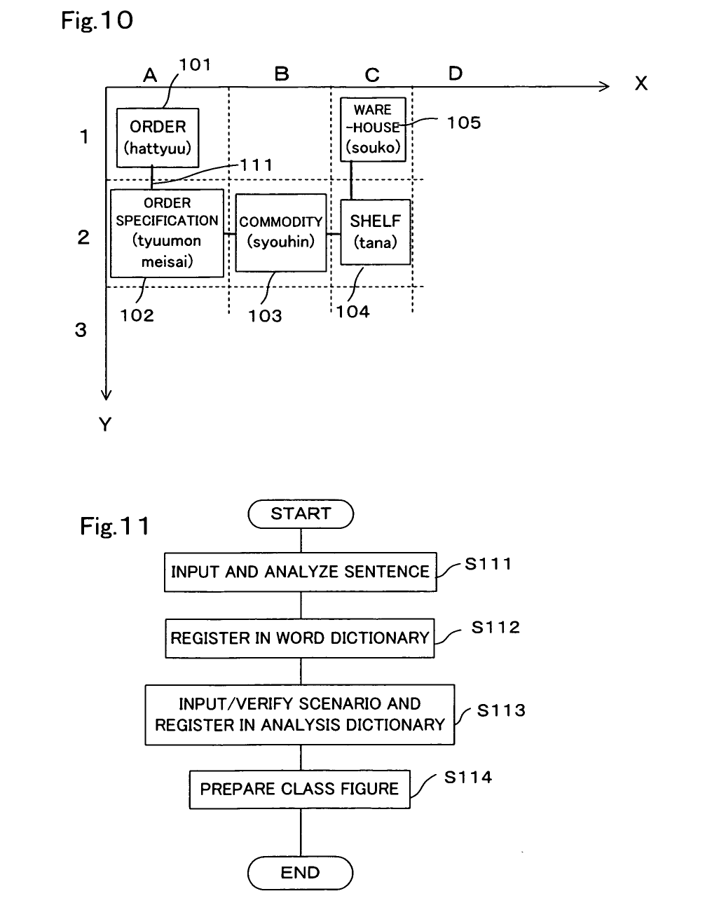

As shown in FIG. 10, firstly, longitudinal and transversal coordinates are set up on the screen for displaying a class figure and lines are drawn as squares.

In a process of registering an analysis dictionary, if there is a subject object showing a linking order at a place (WHERE) set up and registered in advance, the class of the place (WHERE) is set up as a longitudinal column according to the order. The object name is set in the box indicating its class. Then, the set up classes are linked by lines.

Then, the subject object and the object object of a sentence found in the language analysis data of a plurality of sentences to be analyzed are displayed as classes. Then, the object name is set in the box indicating its class and the classes are linked by lines. Each class is displayed at an empty place located very close to it.

More specifically, firstly in Step S901, a series of sentences are input as scenario and the objects located at places for which a linking order is set up are read in. In other words, the objects of the scenario for which the type of WHERE is defined are read in.

Then, in the next step, or Step S902, the subject objects are displayed as classes. In the next step, or Step S903, the classes that are displayed in the above-described manner are linked by lines. FIG. 10 illustrates this example. In FIG. 10, “order” [symbol] 101, “order specification” 102 [symbol] , “commodity” [symbol] 103 are classes and “order” [symbol] 101 and “order specification” 102 [symbol] are linked by line 111. A1 is entered in the column 86 of the order of linkage in the analysis table of FIG. 8. Then, A2 is entered in the column 87 of the order of linkage of the column 82 showing the outcome of analysis of the second sentence and B2 is entered in the column 88 of the order of linkage of the column 83 showing the outcome of analysis of the third sentence.

In this way, the order of linkage is entered for each in the analysis table.

In Step S907, it is checked if the display of classes is completed for all the sentences or not and, if the answer to the question is NO, the processing operation returns to Step S901. Then, in the operations of Steps S901 the outcome of analysis of the next document is input, in the Step S902 classes are displayed, and in the Step S903 linking the classes are repeated.

If the answer to the question in Step S907 is YES and hence the display of classes is completed for all the sentences and the classes are linked by lines, the processing operation proceeds to Step S908 to end the preparation of the class figure.

Thus, with the support apparatus of the first embodiment, it is possible to prepare a class figure with ease.

The subject object of the second sentence that comes immediately after the first sentence is compared with the object object of the first sentence in the above-described embodiment. However, the second sentence may not necessarily come immediately after the first sentence. In other words, the second sentence may be any sentence that comes after the first sentence.

### Second Embodiment

Now, the second embodiment of the invention that is adapted to use a simplified input process will be described below.

In the above-described first embodiment, a series of sentences are input by way of the input section 10 and are analyzed by the input sentence analyzing section 21 and other related sections to extract subject objects and object objects from them.

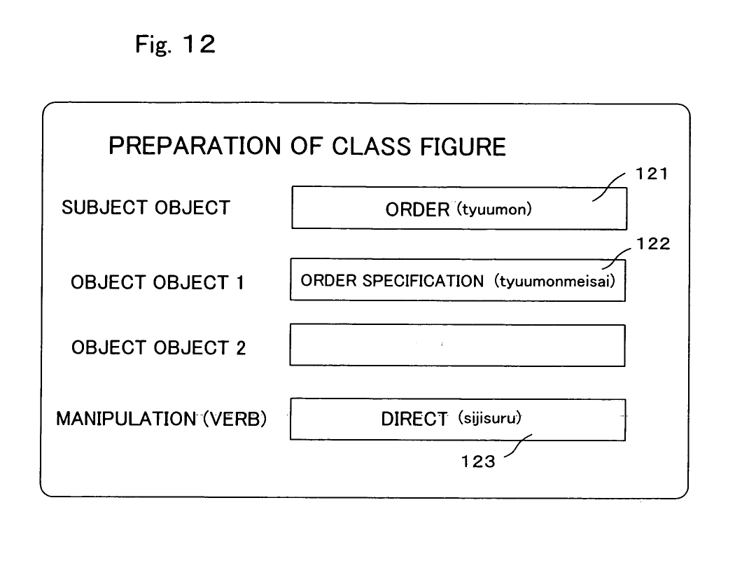

However, it may alternatively be so arranged that the subject object, the object object and the manipulation of each sentence are input separately on the display screen of the input section 10 to simplify the input process. FIG. 11 shows a flowchart of the simplified input process. Referring to FIG. 11, in Step S111, when a sentence is input, the sentence is analyzed and the outcome of analysis is input. More specifically, an image as shown in FIG. 12 is displayed on the display screen of the input section 10 so that the subject object, the object object and the manipulation are input in different sections of the image.

When the first sentence illustrated in FIG. 7A is input, “order” (tyuumon [symbol] , “order specification” (tyuumonmeisai [symbol] and “prepare” (sakuseisuru [symbol] [symbol] are input respectively in the subject object input section 121, in the object object input section 122 and in the manipulation input section 123.

With such a simplified input process, an analysis process of taking out a subject object from each sentence is no longer required. In other words, it is only necessary to check if the outcome of extraction satisfies predetermined requirements or not.

### Third Embodiment

Now, the third embodiment of support apparatus for object-oriented analysis and design according to the invention and adapted to prepare class figures by using English sentences will be described below.

This embodiment is basically same as the support apparatus illustrated in FIG. 1. The control section 24 of the language analysis section 12 is controlled by the program stored in the analysis program memory section 33.

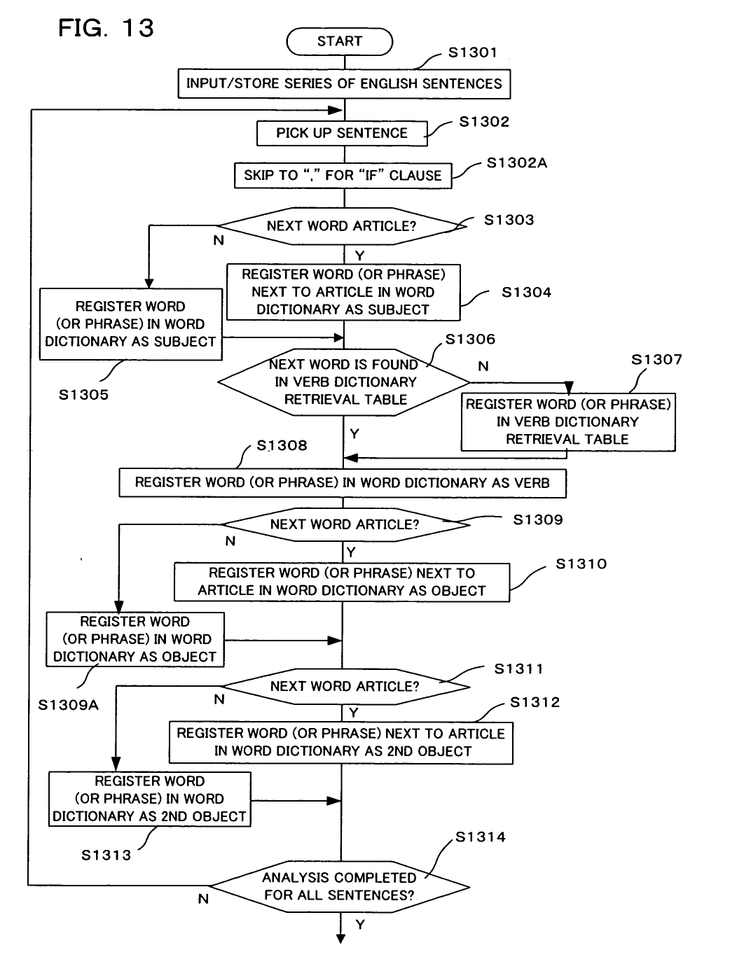

FIGS. 13 and 14 show flowcharts of the operation of this embodiment. Referring firstly to FIG. 13, in Step S1301, the requirement of a system and a series of English sentences are input to the input sentence analyzing section 21 of the language analysis section 12 by way of the input section 10. The input series of sentences (scenario) is temporarily stored in the input sentence analyzing section 21.

In Step S1302, the first sentence is picked up. In Step S1302a, the part of the sentence down to “,” is skipped when the first word of the picked up sentence is “If”, whereas it is determined if the first word of the picked up sentence is an article or not in the next step when the first word is not “If”. If the first word of the sentence is an article, the processing operation proceeds to Step S1304, where the word (or phrase) next to the article is registered in the word dictionary 31 as subject. If, on the other hand, the first word of the sentence is not an article, the first word is registered in the word dictionary 31 as subject (Step S1305).

When the word that appears is in fact two words linked by a hyphen or an under bar such as “WHITE-TABLE” or “WHITE_TABLE”, it is nevertheless registered as a word in the word dictionary 31.

In the next step, or Step S1306, the next word (or phrase) of the sentence is checked to see if the next word (or phrase) can be found in the verb dictionary retrieval table or not. If the word (or phrase) is not found in the verb dictionary retrieval table, it is registered in the verb dictionary retrieval table in Step S1307.

When the word (or phrase) is found in the verb dictionary retrieval table or it is not found in the verb dictionary retrieval table and registered in the latter, the processing operation proceeds to Step S1308, where the word (or phrase) is registered in the word dictionary 31 as verb.

In the next step, or Step S1309, the next word of the sentence is observed and it is checked if the next word is an article or not. If the word is an article, the word (or phrase) next to the article is registered in the word dictionary 31 as object in step S1310. If, on the other hand, the word is not an article, the word is registered in the word dictionary 31 as object in Step S1309a.

In the next step, or Step S1311, it is checked if the next word of the sentence is an article or not. If the word is an article, the word (or phrase) next to the article is registered in the word dictionary 31 as second object in step S1312. If, on the other hand, it is found in Step S1311 that the word is not an article, the word is registered in the word dictionary 31 as second object.

In the next step, or Step S1314, it is checked if all the sentences have been analyzed or not. If there is still an unanalyzed sentence, the processing operation returns to Step S1302, where the sentence is picked up.

If, on the other hand, it is determined in Step S1314 that all the input sentences have been analyzed, the above process is terminated.

Subsequently, the operations similar to those of Step S601 through Step S611 of the first embodiment are performed to prepare an analysis dictionary.

When all the sentences are analyzed, a class figure similar to the one shown in FIG. 10 for the first embodiment is prepared.

Thus, with this third embodiment of support apparatus for object-oriented analysis and design, it is possible to prepare a class figure with ease for English sentences.

The above-described third embodiment may be modified in such a way that the operator can separately input the subject object, the object object and the manipulation of each sentence as in the case of the second embodiment.

It should be noted that the present invention is by no means limited to the above-described embodiments, which may be modified in various different ways without departing from the spirit and scope of the present invention. Such modifications are also found within the scope of the present invention.

What is claimed is:

1. A support apparatus for object-oriented analysis and design comprising:
a sentence input section that receives as input a plurality of sentences of the requirement and the design paper of a system as scenario;
a sentence pickup section that picks up the input plurality of sentences one by one sequentially from the sentence input section;
a subject extracting section that extracts the noun that makes the subject from one of the sentences picked up as target from the requirement of the system by the sentence pickup section;
an object extracting section that extracts the noun as object object on the basis of the input sentences;
a verb extracting section that extracts the verb of the sentence on the basis of the input sentences;
a continuous sentences linking condition confirming section that checks the link of the first sentence and the second sentence, by confirming there is an object object, it differs from the subject object of the same sentence, and the agreement of the object object of the first sentence with the subject object of the second sentence found somewhere after the first sentence in the relationship of the subject objects and the object objects of the first sentence and the second sentence as extracted by the subject extracting section and the object extracting section; and
a class figure preparing section that prepares a class figure from the subject object of the first sentence and the subject object of the second sentence and the link condition of the first sentence and the second sentence confirmed by the continuous sentences linking condition confirming section.

2. The apparatus according to claim 1, wherein
the continuous sentences linking condition confirming section includes:
an object comparing section that compares the subject object and the object object of the first sentences, and compares the object object of the first sentence and the subject object of the second sentence found somewhere after the first sentence; and
a class relevancy setting up section that sets up class relevancy between the subject object of the first sentence with the subject object of the second sentence when the subject object and the object object of the first sentences are different and agreement of the object object of the first sentence with the subject object of the second sentence is confirmed by the object comparing section to the subject object, the object object and the manipulation of each sentence are input separately on the display screen of the input process.

3. A support apparatus for object-oriented analysis and design comprising:
a sentence input section that receives as input a plurality of Japanese sentences including the requirement and the design paper of a system as scenario;
a sentence pickup section that picks up the plurality of sentences input one by one sequentially from the sentence input section;
a separating character detecting section that detects a separating character in the sentence picked up by the sentence pickup section;
an object determining section that determines if the character string immediately preceding the separating character detected by the separating character detecting section is a subject object or an object object;
an object comparing section that compares the subject object and the object object of the first sentences, and compares the object object of the first sentence and the subject object of the second sentence found somewhere after the first sentence in the relationship of the subject objects and the object objects of the first sentence and the second sentence input to the sentence input section;
a class relevancy setting up section that sets up class relevancy between the subject object of the first sentence and the subject object of the second sentence when agreement of the two objects of the first sentence and the second sentence is determined by the object comparing section; and
a class figure preparing section that prepares a class figure on the basis of the link condition of the first sentence and the second sentence as set up by the class relevancy setting up section.

4. The apparatus according to claim 3, wherein
the separating character detecting section and the object determining section are an object input section for inputting subject objects and object objects on the display screen of a display apparatus.

5. A support apparatus for object-oriented analysis and design comprising:
a sentence input section that receives as input a plurality of English sentences including the requirement of a system as scenario;
a sentence pickup section that picks up the input plurality of English sentences one by one sequentially from the sentence input section;
a first article determining section that determines if the first word of the sentence picked up by the section pickup section is an article or not;
a subject object detecting section that detects the word (or phrase) next to the first word as subject object when the first word of the sentence is determined to be an article by the article determining section,
if, on the other hand, the first word of the sentence is not an article, the first word is registered as subject object;
a verb detecting section that determines if the word following the subject object detected by the subject object detecting section is an article or not;
a second article determining section that determines if the word following the verb detected by the verb detecting section is an article or not;
an object object detecting section that detects the word (or phrase) next to the article as determined by the second article determining section as object object and stores it;
an object comparing section that compares the subject object and the object object of the first sentences, and compares the object object of the first sentence stored in a subject object memory section and the subject object of the second sentence found somewhere after the first sentence in the relationship of the subject objects and the object objects of the first sentence and the second sentence;
a class relevancy setting up section that sets up class relevancy between the object object of the first sentence and the subject object of the second sentence when it is determined by the object comparing section that the subject object differs from the object object in the first sentence and the object object agree with the subject object of the second sentence; and
a class figure preparing section that prepares a class figure on the basis of the link condition of the first sentence and the second sentence as set up by the class relevancy setting up section.

6. The apparatus according to claim 5, wherein
the first article determining section, the subject object detecting section, the verb detecting section, the second article determining section and the object object detecting section are an object input section for inputting subject objects and object objects and verbs on the display screen of a display apparatus.
